(19) United States
(12) Patent Application Publication
(10) Pub. No.: US 2008/0202670 A1
(43) Pub. Date: Aug. 28, 2008

(54) Method for making expandable two-color slats for blinds

(76) Inventors: Wen Ying Liang, Fuxing Shiang (TW); Sheng Ying Hsu, Fuxing Shiang (TW); Wu Chung Nien, Fuxing Shiang (TW); Chien Chih Huang, Fuxing Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/709,086

(22) Filed: Feb. 22, 2007

(51) Int. Cl. B29C 65/00

(52) U.S. Cl. 156/160

(57) ABSTRACT

A method for making expandable slats of two different colors for blinds includes a step of rolling overlapped a first strip and a second strip in a direction to make the first and second strips have flat upper and bottom surfaces; a step of connecting two respective longitudinal sides of the first and second strips to each other by an high-frequency machine; a step of expanding the first and second strips from a center of the combination strip and squeezing the two connection sides toward each other by a second roller set; a step of adding adhesive along one of the longitudinal connection sides to form an adhesive portion; a step of wrapping the combination strip on a polygonal frame and the adhesive portion facing inward to form multiple laminated sections on multiple sides of the polygonal frame, and a step of cutting the laminated sections into sub-sections.

### FIELD OF THE INVENTION

The present invention relates to a method for making expandable slots for blinds and the slat is composed of two parts of different colors or textures.

### BACKGROUND OF THE INVENTION

A conventional blind includes a plurality of parallel slats which are connected by tilt cords and lift cords so that when the user operates the tilt cords or the lift cords, the slats are arranged as designed. However, the conventional slats are made as flat strips which can only block the sunshine but cannot keep the cold outside temperature from entering the interior of rooms. Some blinds manufacturers develop expandable slats which can be expanded as hollow tubular members so as to maintain air in the hollow tubular members. The air in the hollow tubular members forms a thick air curtain to prevent loss of temperature. A conventional method for making the hollow tubular members first folds a strip along a central axis to form an upper and lower adhered sides. Adhesive is then spread on the adhesive sides to connect the adhesive sides and the folded strip is then wrapped on a mandrel. However, due to the arrangements of the mechanical parts of the machine for making the hollow tubular, the upper adhesive side often cannot be attached to the lower adhesive side perfectly. Therefore, when the expandable tubular members are pulled, the shape that the expanded hollow tubular members is deformed and not satisfied by the users. Besides, the conventional method can only make the expandable slats with a single color or texture which cannot meet needs of interior design.

The primary object of the present invention intends to provide a method for making expandable slats of blinds and the slats each is composed of two parts of different colors or textures so that when the slats display two colors when expanded.

Another object of the present invention provides a method for making expandable slats wherein adhesive line is located at a center of the slat so that when the slats are expanded, the adhesive portion is pulled in vertical direction so as to ensure the shape of the expandable slats is as desired.

### SUMMARY OF THE INVENTION

The present invention relates to a method for making expandable slats for blinds, and the method comprises a step of rolling overlapped a first strip and a second strip in a direction by a first roller set so as to make the first and second strips have flat upper and bottom surfaces; a step of connecting two respective longitudinal sides of the first and second strips to each other by an high-frequency machine so as to form a combination strip with two longitudinal connection sides; a step of expanding the first and second strips from a center of the combination strip and squeezing the two connection sides toward each other by a second roller set to form a first folding line and a second line; a step of adding adhesive along one of the longitudinal connection sides to form an adhesive portion; a step of wrapping the combination strip on a polygonal frame and the adhesive portion facing inward so as to form multiple laminated sections on multiple sides of the polygonal frame, and a step of cutting: cutting the laminated sections into sub-sections.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the arrangement of the mechanical parts of the method of the present invention;

FIG. 2 shows the status of the strip in each step of the method of the present invention;

FIG. 3 shows the sub-sections and the expanded status of the sub-section;

FIG. 4 shows the slats made by the method of the present invention of a blind;

FIG. 5 shows another type of slats made by the method of the present invention;

FIG. 6 shows that the sub-section is cut in two halves and each half is expanded;

FIG. 7 shows adhesive is added along the connection side and spreads on the first and second strips, and

FIG. 8 shows the first and second strips are separated along the adhesive portion.

### DETAILED DESCRIPTION OF THE PREFERRED EMBODIMENT

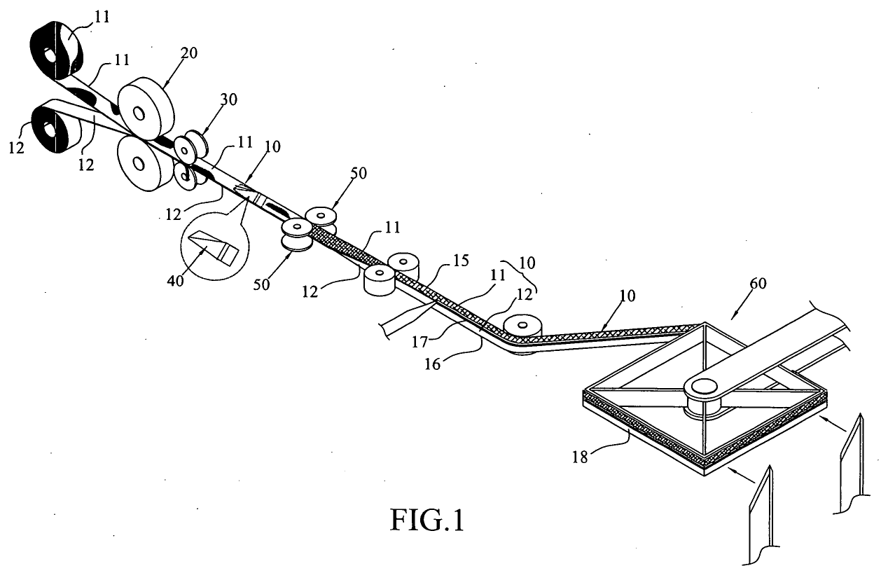

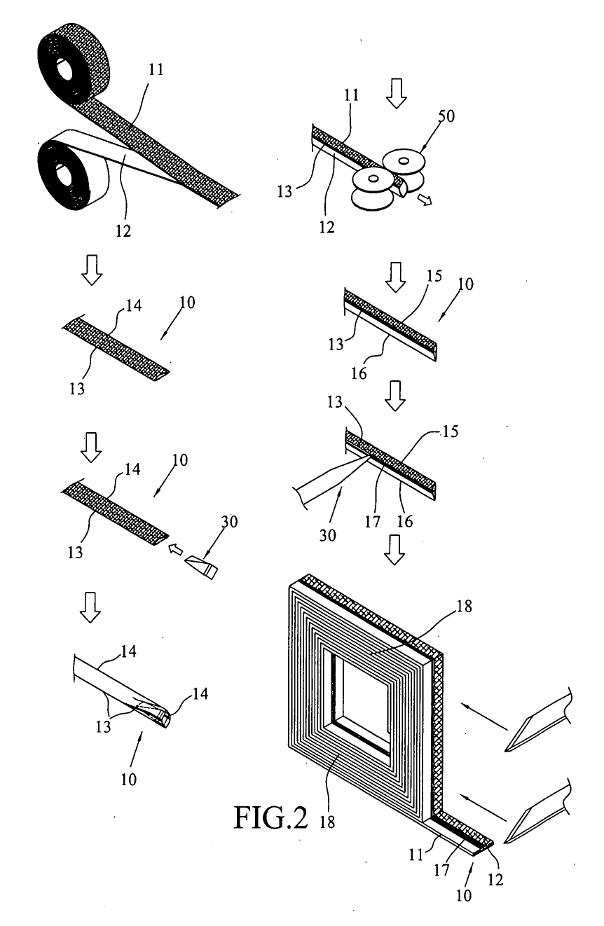

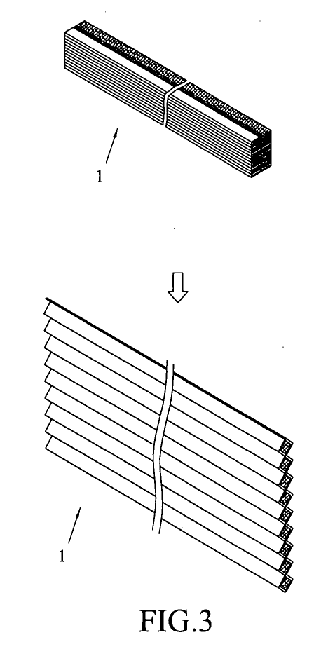

Referring to FIGS. 1 to 3, the method for making expandable slats with two colors or textures for blind of the present invention comprises the following steps:

a step of flatting strips: rolling overlapped a first strip 11 and a second strip 12 in a direction by a first roller set 20 so as to make the first and second strips 11, 12 have flat upper and bottom surfaces. The first and second strips 11, 12 may have different colors or textures.

a step of combination: connecting two respective longitudinal sides of the first and second strips 11, 12 to each other by an high-frequency machine so as to form a combination strip 10 with two longitudinal connection sides 13, 14. The two respective connected connection sides 13, 14 are trimmed to be straight sides when needed. a step of expanding: expanding the first and second strips 11, 12 from a center of the combination strip 10 and squeezing the two connection sides 13, 14 toward each other by a second roller set 50 to form a first folding line 15 and a second folding line 16. The second roller set 50 of the step of expanding includes two rollers which are located on two sides of the combination strip 10. The expanding process uses a separation member 40 which has a wedge-shaped end and is located between the first and second strips 11, 12. The step of expanding proceeds under high temperature.

a step of gluing: adding adhesive along one of the longitudinal connection sides 13, 14 to form an adhesive portion 17, in this embodiment, the connection side 13 is spread with the adhesive. The adhesive is spread on the first and second strips 11, 12 along the connection side 13 to form the adhesive portion 17.

a step of wrapping: wrapping the combination strip 10 on a polygonal frame 60 such as a rectangular frame and the adhesive portion 17 faces inward so as to form multiple laminated sections 18 on multiple sides of the polygonal frame 60.

a step of cutting: cutting the laminated sections 60 into sub-sections 1.

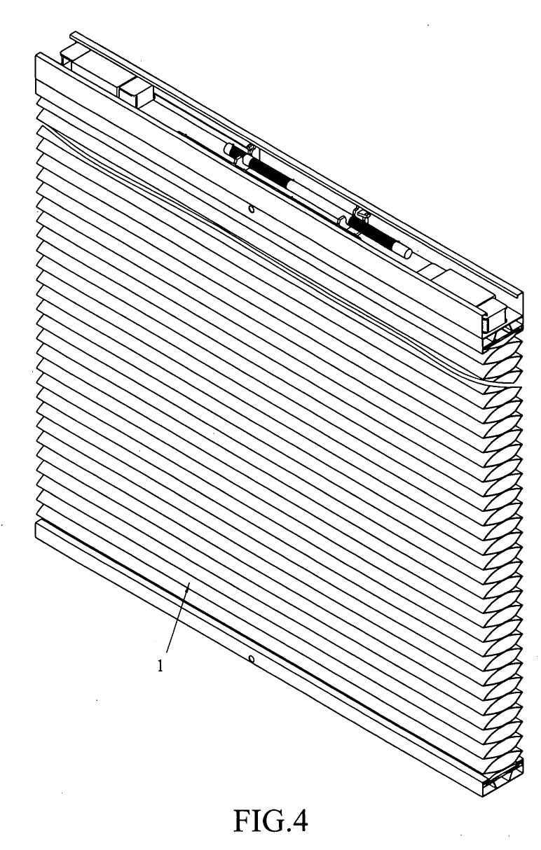

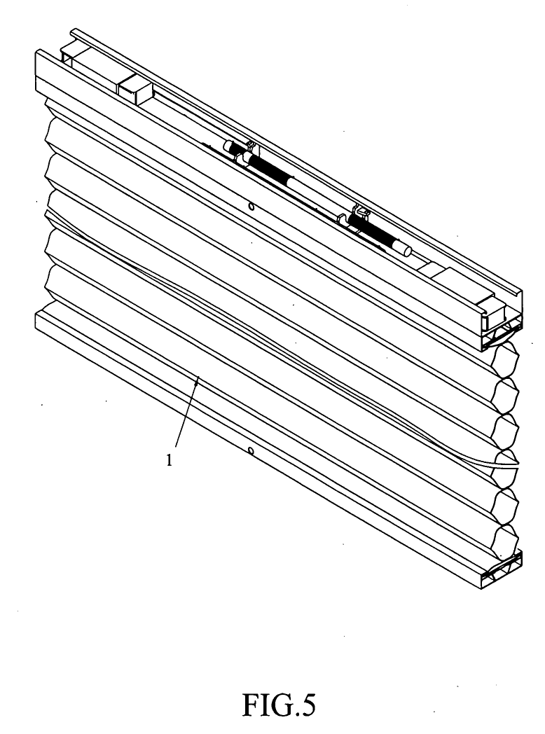

When the laminated section 18 is pulled in two opposite directions as shown in FIG. 4, each layer of the laminated section 18 is expanded to be a hollow tubular member as shown. The adhesive portions 17 are located at a center of each expandable slat. FIG. 5 shows that the expandable slats are expanded fully.

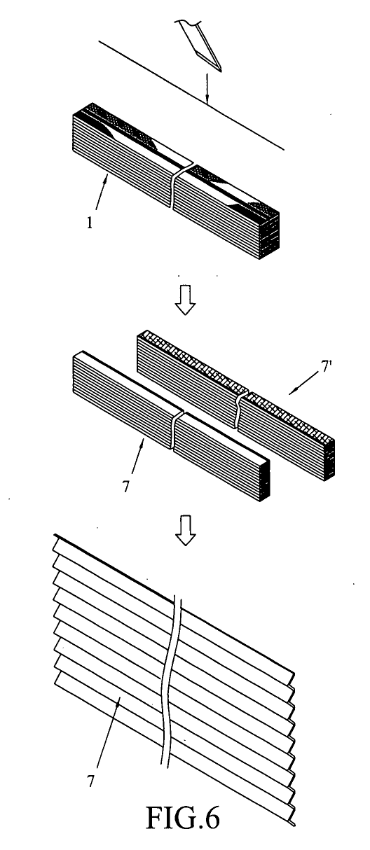

FIG. 6 shows that a step of secondary cutting can be taken and which cuts the sub-sections 18 along a central axis thereof so as to form two halves 7, 7′. Each half 7/7′ forms a continuous single layer slat.

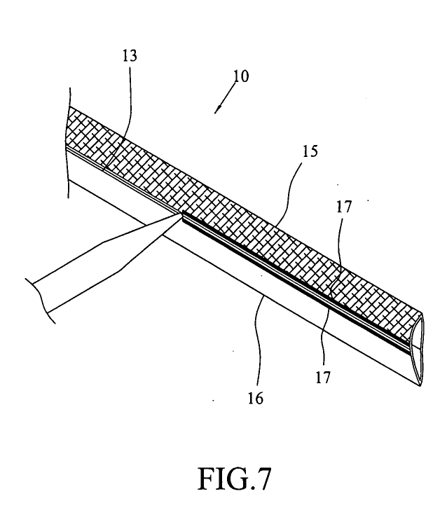

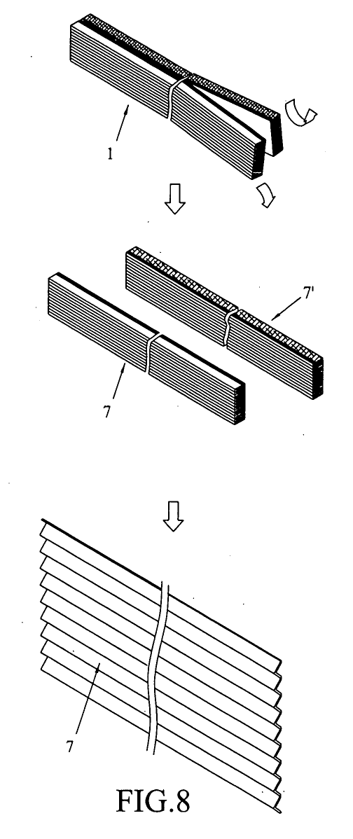

FIGS. 7 and 8 show that the adhesive portion 17 is formed by adding the adhesive to the connection side 13 of the combination strip 10 and the adhesive spreads to the first and second strips 11, 12 of the combination strip 10. A step of separation is proceeded which separates the first and second strips 11, 12 to form two halves 7, 7′. Each half 7/7′ forms a continuous single layer slat.

While we have shown and described the embodiment in accordance with the present invention, it should be clear to those skilled in the art that further embodiments may be made without departing from the scope of the present invention.

What is claimed is:

1. A method for making expandable slats for blinds, comprising:
a step of flatting strips: rolling overlapped a first strip and a second strip in a direction by a first roller set so as to make the first and second strips have flat upper and bottom surfaces;
a step of combination: connecting two respective longitudinal sides of the first and second strips to each other by an high-frequency machine so as to form a combination strip with two longitudinal connection sides;
a step of expanding: expanding the first and second strips from a center of the combination strip and squeezing the two connection sides toward each other by a second roller set to form a first folding line and a second folding line;
a step of gluing: adding adhesive along one of the longitudinal connection sides to form an adhesive portion;
a step of wrapping: wrapping the combination strip on a polygonal frame and the adhesive portion facing inward so as to form multiple laminated sections on multiple sides of the polygonal frame, and
a step of cutting: cutting the laminated sections into sub-sections.

2. The method as claimed in claim 1, wherein a separation member is used in the step of expanding and includes a wedge-shaped end which is located between the first and second strips.

3. The method as claimed in claim 1, wherein the step of expanding proceeds under high temperature.

4. The method as claimed in claim 1, wherein the second roller set of the step of expanding includes two rollers which are located on two sides of the combination strip.

5. The method as claimed in claim 1, wherein the adhesive is spread on the first and second strips along the connection side to form the adhesive portion.

6. The method as claimed in claim 1, wherein the adhesive portion adheres the connection side the combination strip laminated on the adhesive portion in the step of wrapping.

7. The method as claimed in claim 1 further comprising a step of secondary cutting which cuts the sub-sections along the connection sides so as to form two halves.

8. The method as claimed in claim 1 further comprising a step of separation which separates the first and second strips to form two halves.
